(19) United States
(12) Patent Application Publication
(10) Pub. No.: US 2012/0032875 A1
(43) Pub. Date: Feb. 9, 2012

(54) Scanned Image Projection System Employing Beam Folding Apparatus

(75) Inventors: Robert A Sprowl, Sammamish, WA (US); Margaret K. Brown, Seattle, WA (US)

(73) Assignee: MICROVISION, INC., Redmond, WA (US)

(21) Appl. No.: 12/851,378

(22) Filed: Aug. 5, 2010

(51) Int. Cl. G09G 5/00; G02B 27/01; G03B 21/28

(52) U.S. Cl. 345/156; 353/98; 359/630

(57) ABSTRACT

An imaging system (100) includes one or more light sources (101,102,103) configured to produce one or more light beams (104,105,106). An additional light source (111) produces an additional light beam (112), which may be a non-visible light beam like an infrared beam. A spatial light modulator (107) is configured to produce images (109) on a projection surface (110) by scanning the light beams and the additional light beam within an image cone (118) oriented in a first direction (119). A partial reflector (117) is disposed within the image cone (118) and is configured to pass at least a portion of the light beams and reflect at least a portion of the additional light beam within a second cone (120) oriented in a second direction (121).

### BACKGROUND

1. Technical Field

This invention relates generally to scanned image projection systems, and more particularly to a scanned image projection system employing a beam folder to partially reflect scanned light.

2. Background Art

Scanned image projection systems, such as those employing scanned lasers, facilitate the production of brilliant images created with vibrant colors. These scanned laser projection systems are generally brighter, sharper, and have a larger depth of focus than do conventional projection systems. Further, the advent of semiconductor lasers and laser diodes allows laser projection systems to be designed as compact projection systems that can be manufactured at a reasonable cost. These systems consume small amounts of power yet deliver bright, complex images.

With traditional image projection systems, a presenter making a presentation must face the same projection surface as the audience to view the projected images. This results in the presenter generally having his back facing the audience, which is less than desirable. Additionally, to control the image, the presenter must use a control device that is tethered to the image projection system, such as a mouse or keypad. This “hard wire” restriction limits the mobility of the presenter while making a presentation.

It would be advantageous to provide from an image projection systems a plurality of images, and optionally the ability to control the image projection system without the need of a mouse or keyboard.

### BRIEF DESCRIPTION OF THE DRAWINGS

FIG. 1 illustrates one embodiment of a scanned image projection system employing a beam folding apparatus in accordance with embodiments of the invention.

FIG. 2 illustrates a schematic block diagram of one embodiment of a scanned image projection system employing a beam folding apparatus in accordance with embodiments of the invention.

FIG. 3 illustrates one embodiment of a spatial light modulator suitable for use with one or more embodiments of a scanned image projection system employing a beam folding apparatus in accordance with embodiments of the invention.

FIG. 4 illustrates another embodiment of a scanned image projection system employing a beam folding apparatus in accordance with embodiments of the invention.

FIG. 5 illustrates another embodiment of a scanned image projection system employing a beam folding apparatus in accordance with embodiments of the invention.

FIG. 6 illustrates another embodiment of a scanned image projection system employing a beam folding apparatus and incorporating a head-up display in accordance with embodiments of the invention.

FIG. 7 illustrates one embodiment of a projection surface suitable for use with one or more embodiments.

FIG. 8 illustrates one embodiment of head-up projection surface suitable for use with one or more embodiments, including the embodiment of FIG. 6.

FIG. 9 illustrates an exemplary head-up projection surface suitable for use with one or more embodiments, including the embodiment of FIG. 6.

FIG. 10 illustrates another embodiment of a head-projection surface suitable for use with one or more embodiments, including the embodiment of FIG. 6.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it will be appreciated that embodiments of the invention described herein may be comprised of one or more conventional processors and unique stored program instructions that control the one or more processors to implement, in conjunction with certain non-processor circuits, some, most, or all of the functions of presenting multiple images or permitting a user to control image content as described herein.

The non-processor circuits may include, but are not limited to, microprocessors, scanning mirrors, image encoding devices, memory devices, clock circuits, power circuits, and so forth. As such, these functions may be interpreted as steps of a method to perform multiple image delivery or image projection system control. It is expected that one of ordinary skill, notwithstanding possibly significant effort and many design choices motivated by, for example, available time, current technology, and economic considerations, when guided by the concepts and principles disclosed herein will be readily capable of generating such programs and circuits with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present invention provide an imaging system employing one or more light sources, which in one embodiment are semiconductor laser sources having the colors of red, green, and blue. Light from the sources is scanned or otherwise modulated by a spatial light modulator to form images on a projection surface. A selective or partial reflector is disposed between the imaging system and the projection surface and is configured to function as a beam folding apparatus. The selective reflector reflects a portion of the spatially modulated light in a second direction towards a second projection surface. In one embodiment, an alternate light source, such as an infrared light source, can be modulated along with the other light sources. Reflections from this additional light source, such as reflections from a user's hand, can be detected by the imaging system and used as a control input. The reflections can be used, for example, to move a cursor or other content within the image. Embodiments of the present invention thus provide an auxiliary image for a person to view. Some embodiments further provide a method of controlling the image content that does not require a hard-wired mouse or keyboard.

In one embodiment, the selective reflector is manufactured from a selective mirror, a dielectric coating, a customized reflective layer, or prism. The selective reflector is configured to pass one portion of the modulated light and reflect another. The selective reflector can cause the reflection based upon polarization or wavelength. Alternatively, the selective reflector can simply reflect a percentage of the modulated light to form a second image that is the same as the one passing through the selective reflector.

Illustrating by way of one simple example, where the light sources are emissions from a red laser, a green laser, and a blue laser, and the additional source is an infrared laser, the selective reflector can be configured to pass the visible light and reflect the infrared light in a different direction, which may be away from the projection surface. By passing a hand or other object within the reflected infrared projection cone, a user can cause reflections to be directed from the object back to the selective reflector and to a sensor in the imaging system. These reflections can be used as an input, such as to control a cursor or other image contents. The sensor can be configured, in conjunction with a processor or other control circuit, to recognize hand gestures or other motion to affect the image content.

In another embodiment, two sets of light sources are used. Each set of light sources is amplitude modulated with a different signal such that the resulting light is configured to produce different images. A first image can be passed through the selective reflector while a second image is reflected to a second projection surface. Accordingly, a user may be able to read a narrative created by the second image while viewers see video corresponding to the narrative in the first image. Either or both of the first image and second image can include a modulated alternate light source. The user may then use hand gestures made within either or both of the first image and second image to alter image content.

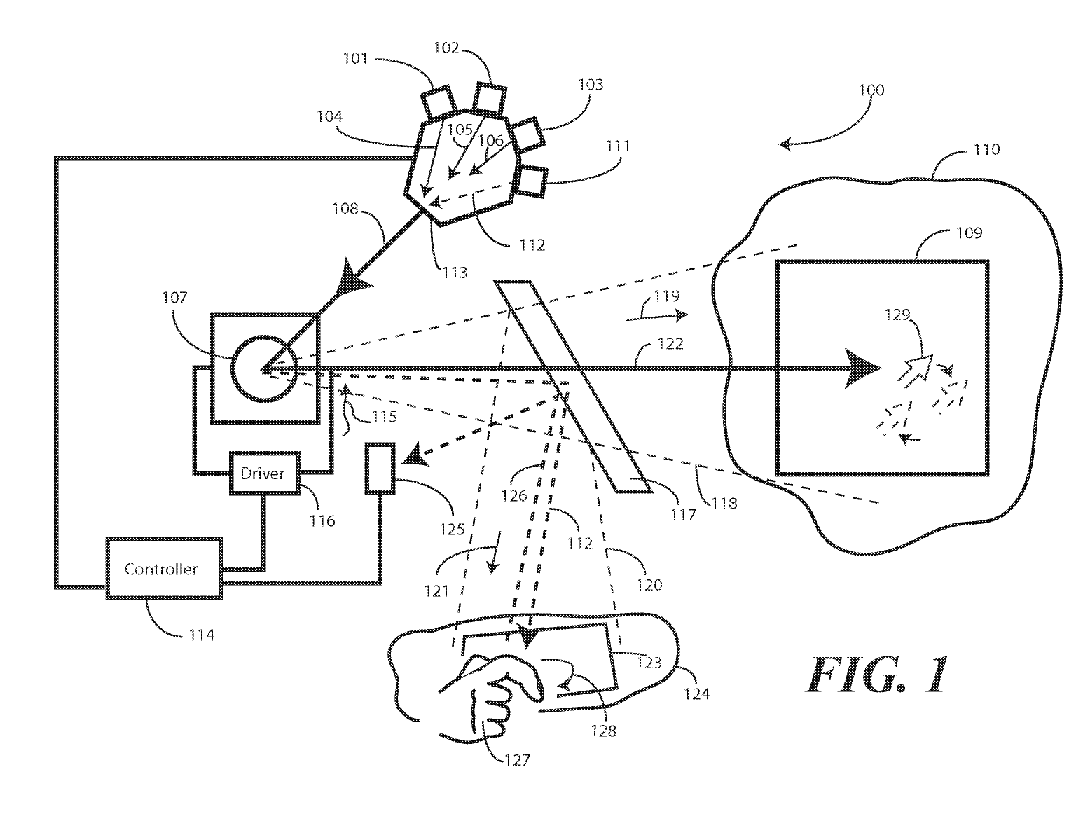

Turning now to FIG. 1, illustrated therein is one embodiment of an imaging system 100 configured in accordance with one or more embodiments of the invention. The imaging system 100 includes one or more light sources 101,102,103 that are configured to produce one or more light beams 104,105,106. In one embodiment, the one or more light sources 101,102,103 are laser light sources, such as those created by semiconductor laser sources. In the illustrative embodiment of FIG. 1, the one or more light sources 101,102,103 comprise a red light source, a green light source, and a blue light source. A spatial light modulator 107 scans or otherwise modulates the light 108 to produce images 109 on a projection surface.

In one embodiment, an additional light source 111 is modulated along with the one or more light sources 101,102,103. In the illustrative embodiment of FIG. 1, the additional light source 111 is a non-visible light source and is configured to produce an alternate, non-visible light beam 112. While a non-visible light source, such as an infrared or ultraviolet light source is one suitable additional light source 111, it will be clear to those of ordinary skill in the art having the benefit of this disclosure that other light sources could be used as the additional light source 111. For instance, a designer may select a predefined color, such as purple or pink, to use as the additional light source 111 as well. A beam combiner 113 combines the output of the light sources 101,102,103,111 to produce a combined beam of light 108. An optional collimation or focusing optical element may be included between the light sources 101,102,103,111 and the spatial light modulator 107.

The spatial light modulator 107 is configured to produce images 109 by scanning the combined beam of light 108 along a projection surface 110, which may be a wall, screen, or other surface. The spatial light modulator 107, which may be a scanning mirror or other modulation device, is operable with and responsive to a controller 114. In one embodiment, the spatial light modulator 107 receives the combined beam of light 108 and deflects in response to a drive signal 115 from a driver 116 that is operable with the controller 114. This pivoting action scans the combined beam of light 108 within an image cone 118 extending in a first direction 119 to form the image 109. In one embodiment, the scan occurs horizontally and vertically in a raster pattern.

A partial reflector 117 is disposed within the image cone 118 formed by the spatial light modulator 107. The partial reflector 117 is configured to pass at least a portion of the combined beam of light 108 in the first direction 119 and reflect at least a portion of the additional light beam 112 within a second cone 120. In one embodiment, the second cone 120 is oriented in a second direction 121 that is different from the first direction 119. For example, the second direction can be substantially orthogonal with the first direction 119, or can form either an acute or obtuse angle with the first direction 119. Additionally, the second direction 121 can extend outward radially at any angle as well. While shown as extending down in the illustrative embodiment of FIG. 1, it could equally extend out of the page, upward, into the page, or at other radial angles relative to the first direction 119.

The partial reflector 117 can be formed from any of a number of materials. In one embodiment, the partial reflector 117 comprises a prism. In another embodiment, the partial reflector 117 comprises a selective mirror that is configured to reflect some light beams and transmit others. In one embodiment, the selective reflection is based upon wavelength, where some wavelengths are transmitted and others are reflected. In another embodiment, the selective reflection is based on polarization, where light beams having a first polarization are transmitted, while light beams having a second polarization are reflected. In yet another embodiment, the selective reflection is simply a percentage of the scanned beam 122, such that a first portion of the whole is transmitted and a second portion of the whole is reflected.

In one embodiment, the partial reflector 117 comprises an optical coating, which may be disposed on a substrate. The optical coating functions as a selective coating or filter. A suitable optical coating may comprise a multilayer, thin film, dielectric coating that includes materials such as magnesium oxide or magnesium fluoride. In certain coatings, some layers may be thicker than others. Further, the layers may have indices of refraction that differ from each other by varying amounts. The coatings can be configured to provide the selective reflection properties as described herein. As is known in the art, many optic coating manufacturers are capable of receiving reflective and transmissive requirements associated with a particular application and delivering a coating tailored to those requirements. For instance, exemplary coatings may be obtained from optical product suppliers such as Cascade Optical Corporation of Santa Ana, Calif., USA or Deposition Sciences Inc of Santa Rosa, Calif., USA.

In one embodiment, the second cone 120 comprises only the additional light beam 112. In this embodiment, where the additional light beam 112 is non-visible, the image 109 is produced by the visible light beams 104,105,106 that are transmitted through the partial reflector 117. The partial reflector 117 is configured to reflect the additional light beam 112 along the second direction 121.

In another embodiment, the second cone 120 comprises at least a portion of the additional light beam 112 and a portion of the visible light beams 104,105,106. Accordingly, a second image 123 can be formed on a second projection surface 124. In such an embodiment, the second image 123 will be a replication of the original image 109. In this embodiment, all of the additional light beam 112 can be reflected within the second cone 120, or only a portion. In the latter scenario, the first image cone 118 would include a portion of the additional light beam 112 as well.

A sensor 125, which can be a photodetector or other sensor and which is operable with the controller 114, is then configured to detect reflections 126 of the additional light beam 112 from the partial reflector 117. The sensor 125 can convert the reflections 126 into analog or digital signals indicative of, for example, location and intensity. The signals are then delivered to the controller 114. In one embodiment, the sensor 125 can include a filter configured to keep the signal to noise ratio within a predetermined limit. For example, where infrared light is used for the additional light beam 112, the sensor 125 may include an integrated infrared filter to ensure that signals detected by the sensor 125 only from infrared light.

In one embodiment, the controller 114 is then configured to use the reflections 126 as an input to control the imaging system 100. Illustrating by example, in one embodiment a user may make hand gestures 128 or other motions within the second cone 120. Accordingly, the reflections 126 comprise reflections from the user's hand 127. The controller 114 can be configured with executable instructions configured as software or firmware to recognize the hand gestures 128 as control signals. These control signals can be used to move, for example, a cursor 129 within the image 109. Such movement would be useful in making a presentation, as the presented would be able to make the hand gestures 128 within the second cone 120, thereby preventing the addition of shadows or other unnecessary artifacts from appearing in the image 109 being viewed by the audience. Where the second cone includes both the visible light beams 104,105,106 and the additional light beam 112, the presenter would instantly know where his hand 127, and therefore the corresponding cursor 129, was by looking at the second image 123. Note that while a user's hand 127 is one object suitable for control, it will be clear those of ordinary skill in the art having the benefit of this disclosure that embodiments of the invention are not so limited. Rather than reflecting from a hand, the additional light beam 112 could reflect from a stylus, pointer, or other object being held by the user. Further, such objects could be configured with reflective layers to enhance the reflections 126.

The embodiment of FIG. 1 can also be expanded in other ways. Where, for example, the controller 114 is applying amplitude modulation to the light sources 101,102,103 to create video, the hand gestures 128 can be used by the controller to alter the video content. Where, for example, the video content was an animation of a bear walking through the woods, the hand gestures 128 could cause the bear to move. Numerous other extensions of embodiments of the invention will be readily apparent to those of ordinary skill in the art having the benefit of this disclosure.

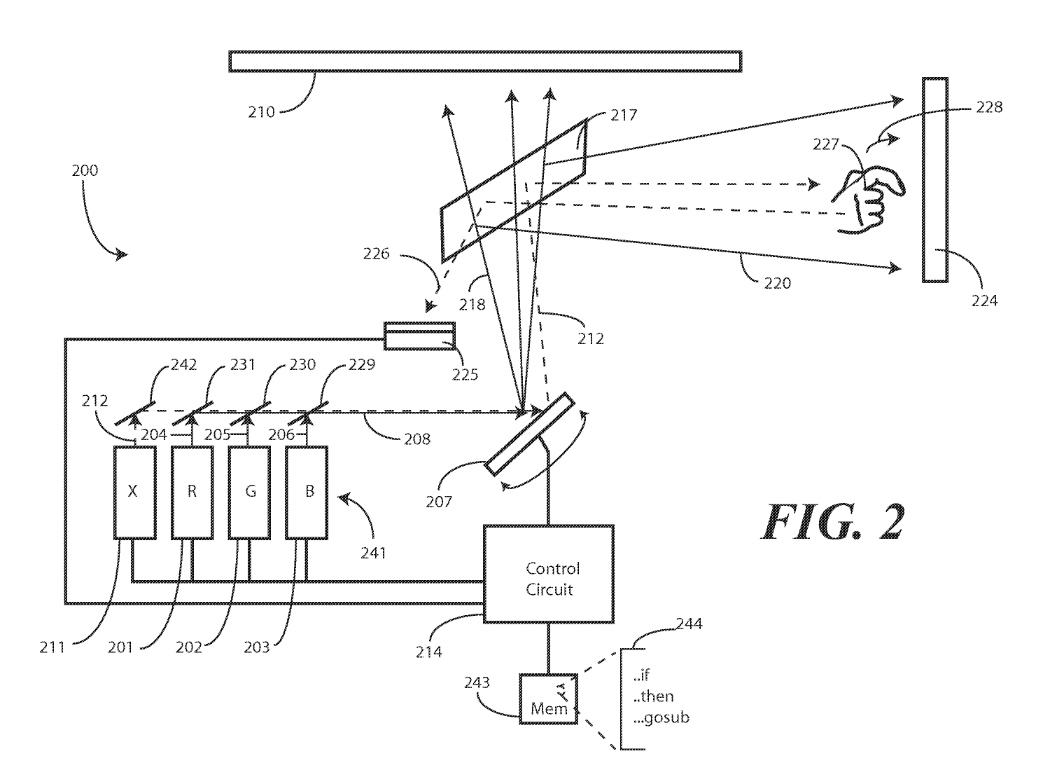

Turning now to FIG. 2, illustrated therein is a schematic block diagram of an alternate embodiment of an image projection system 200 configured in accordance with embodiments of the invention. FIG. 2 illustrates a general block diagram of the scanned image projection system, with one or more laser sources 241 configured to produce a plurality of light beams. In one embodiment, the one or more laser sources 241 comprise a red laser 201, a blue laser 202, and a green laser 203, as indicated by the “R,” “G,” and “B.” The lasers can be any of various types of lasers. For example, in one embodiment, each laser source 241 is a semiconductor laser, such as an edge-emitting laser or vertical cavity surface emitting lasers. Such semiconductor lasers are well known in the art and are commonly available from a variety of manufacturers.

A spatial light modulator 207 is then configured to produce images by spatially encoding the light from the laser sources 241 along a projection surface 210. In one embodiment, the spatial light modulator 207 comprises a Micro-Electro-Mechanical-System (MEMS) scanning mirror, such as those manufactured by Microvision, Inc. Examples of MEMS scanning mirrors, such as those suitable for use with embodiments of the present invention, are set forth in commonly assigned U.S. patent application Ser. No. 11/786,423, filed Apr. 10, 2007, entitled, “Integrated Photonics Module and Devices Using Integrated Photonics Module,” which is incorporated herein by reference, and in U.S. Published patent application Ser. No. 10/984,327, filed Nov. 9, 2004, entitled “MEMS Device Having Simplified Drive,” which is incorporated herein by reference. While a scanning mirror is one type of spatial light modulator suitable for use with embodiments of the invention, it will be clear to those of ordinary skill in the art having the benefit of this disclosure that the invention is not so limited. Other types of spatial light modulators, such as a spinning wheel found digital light projection technology systems, can also be used.

To permit the designer to orient the one or more laser sources 241 in various ways relative to the spatial light modulator 207, one or more optical alignment devices 231,230,229 may optionally be used to direct light beams 204,205,206 from the one or more laser sources 241 to the spatial light modulator 207. For example, the one or more optical alignment devices 231,230,229, in one embodiment, are used to orient the plurality of light beams 204,205,206 into a single, collimated light beam 208. Where the one or more laser sources 241 comprise a red laser 201, blue laser 202, and green laser 203, the one or more optical alignment devices 231,230,229 can blend the output of each laser to form a collinear beam of light.

In one embodiment, dichroic mirrors are used as the one or more optical alignment devices 231,230,229. Dichroic mirrors are partially reflective mirrors that include dichroic filters that selectively pass light in a narrow wavelength bandwidth while reflecting others. In one embodiment, polarizing coatings can be incorporated into the dichroic mirrors as well. Dichroic mirrors and their use in laser-based projection systems are known in the art and, as such, will not be discussed in further detail here. Note that the location, as well as the number, of the optical alignment devices 231,230,229 can vary based upon application. For example, in some MEMS-type scanning systems, the plurality of light beams 204,205,206 can be delivered directly into the spatial light modulator 207. Alternatively, some applications may not require optical alignment devices 231,230,229.

An additional light source 211, which in one embodiment is a non-visible light source, is co-located with the laser sources 241. In the illustrative embodiment of FIG. 2, the additional light source 211 can be, for example, an infrared light source or an ultraviolet light source. As with the laser sources 241, the additional light source 211 can be a semiconductor light source such as a light emitting diode. One example of a non-visible light source suitable for use as the additional light source 211 is an infrared light emitting diode having a wavelength of around 800-810 nanometers. Another example of a non-visible light source suitable for use as the additional light source 211 is an ultraviolet light emitting diode having a wavelength of around 400-410 nanometers. It will be clear to those of ordinary skill in the art having the benefit of this disclosure that the invention is not so limited, as any number of other non-visible light sources or visible light sources can be used as the additional light source 211 as well.

In one embodiment, the additional light source 211 is disposed within the image projection system 200 such that the additional light beam 112 is generally collinear with the other light beams 204,205,206. Where necessary, an additional optical alignment device 242 can be used to orient the additional light beam 212 so as to be collinear with the combined light beam 208. The spatial light modulator 207 is then able to modulate or encode the additional light beam 212 along with the other light beams 204,205,206.

A selective reflector 217 is disposed within an image cone 218 created by the spatial light modulator 207. The selective reflector 217, like the partial reflector (117) from FIG. 1 above, is configured to reflect a portion 220 of the image cone 218 in a second direction 221. In one embodiment, the portion 220 comprises only the additional light beam 112, with the other light beams 204,205,206 being passed through the selective reflector 217 so as to produce an image on the projection surface 210. In another embodiment, the portion 220 comprises at least a portion of the additional light beam 212 and a portion of the other light beams 204,205,206. Accordingly, a second image can be formed on a second projection surface 224. All of the additional light beam 212 can be reflected, or only a portion.

A sensor 225 is then configured to receive reflections 226 of at least some of the portion 220 and create electrical signals corresponding to the reflection intensity, location, or other data as sensed by a detector in the sensor 225. In one embodiment, the sensor 225 is configured as a charge coupled device photodetector. In another embodiment, the sensor 225 is configured as a CMOS photodetector. Other types of sensors 225 may also be used. The sensor 225 effectively captures an “image” of the reflection 226 from the selective reflector 217 and delivers a corresponding signal to a control circuit 214.

The control circuit 214, which may be a microcontroller, a microprocessor, ASIC, logic chip, or other device, serves as the brain of the image projection system 200. The control circuit 214 can include other processing units dedicated to performance of specific functions. For example, an integrated or stand-alone digital signal processor may handle the processing of incoming communication signals or data. In the illustrative embodiment of FIG. 2, the control circuit 214 is shown for simplicity as an integrated circuit, but shall be understood to be representative of any processing architecture known to those skilled in the art.

The control circuit 214 can be a single processor, such as a microprocessor integrated circuit, or alternatively may comprise one or more processing units or components. The control circuit 214 is coupled to a memory 243 or other computer readable medium. By executing operable code 244 stored in the memory 243, the control circuit 214 is capable of causing the various components of the image projection system 200 to execute their respective functions.

In one embodiment, the control circuit 214 executes operable code 244 comprising one or more routines stored in the memory 243. The memory 243 may comprise a separate and distinct integrated circuit connected and operable with the control circuit 214 via a data bus. Further, the memory 243 may include one or more read-only memories, dynamic or static random-access memory, or any other type of programmable memory, such as one or more EPROMs, EEPROMs, registers, and the like. In some embodiments, the memory 243 can comprise non-traditional storage devices as well. The routines stored in the memory 243 can be stored in the form of executable software, firmware, or in any other fashion known to those skilled in the art.

In one embodiment, the control circuit 214 is configured to use the reflections 226 as input for controlling the image projection system 200. A user may make hand gestures 228 or other motions within the portion 220, which causes reflections 226 from the user's hand 227 or other objects to reflect off the selective reflector 213 to the sensor 225. The operable code 244 in the memory 243 can instruct the control circuit 214 to recognize the hand gestures 228 as control signals. As described above, these control signals can be used to move a cursor within an image 109, or to control content of images being displayed on the projection surface 210.

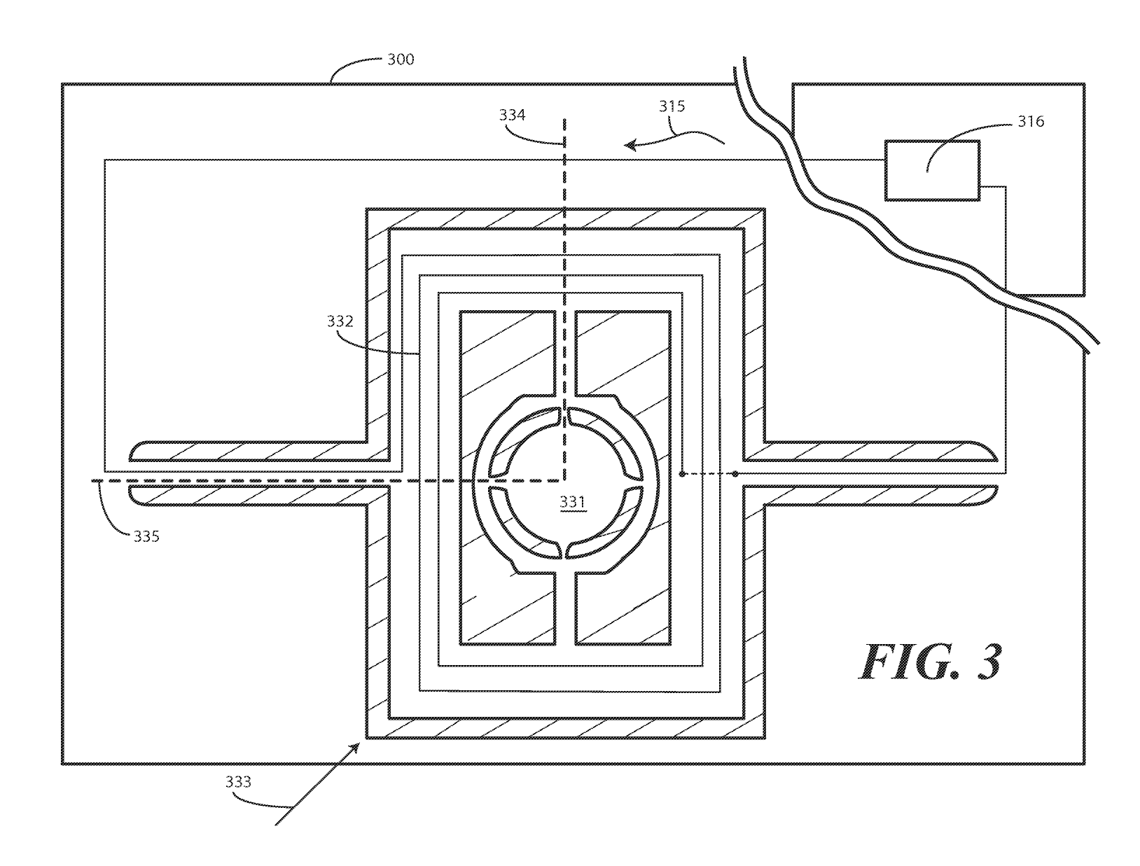

Turning now to FIG. 3, illustrated therein is one example of a spatial light modulator 307 suitable for use with various embodiments of the invention. As noted above, one or more embodiments can employ a MEMS scanning platform such as that described in commonly assigned U.S. patent application Ser. No. 12/496,892, filed on Jul. 2, 2009, entitled, “Phase Locked Resonant Scanning Display Projection,” which is incorporated herein by reference. Such a spatial light modulator 307 is shown in FIG. 3. Note that there are many different ways in which a spatial light modulator can be constructed, and the MEMS scanning platform is but one example. Further, other spatial light modulators can be substituted for the spatial light modulator 307 of FIG. 3, which is illustrative only.

The principal scanning component of the spatial light modulator 307 is a scanning mirror 331. A driver 316, which may be integrated with a control circuit, delivers a drive signal 315 to a drive coil 332 disposed about the scanning mirror 331. The drive signal 315 causes a corresponding current to pass through the windings of the drive coil 332. An external magnetic field source disposed near the light encoder (not shown) imposes a static magnetic field on the coil 332. The magnetic field has a component 333 in the plane of the coil, and is oriented non-orthogonally with respect to the two drive axes 334,335. The in-plane current in the windings of the coil 332 interacts with the in-plane magnetic field component 333 to produce out-of-plane Lorentz forces on the conductors of the coil 332. As the drive current forms a loop, the current reverses sign across the scan axes, which causes the Lorentz forces to also reverse sign across the scan axes, thereby causing the application of mechanical torque. This combined torque produces responses in the two scan directions, depending on the frequency content of the torque, thereby causing motion about the axes 334,335. This motion permits the driver 316, or the control circuit via the driver, to scan an image on a projection surface.

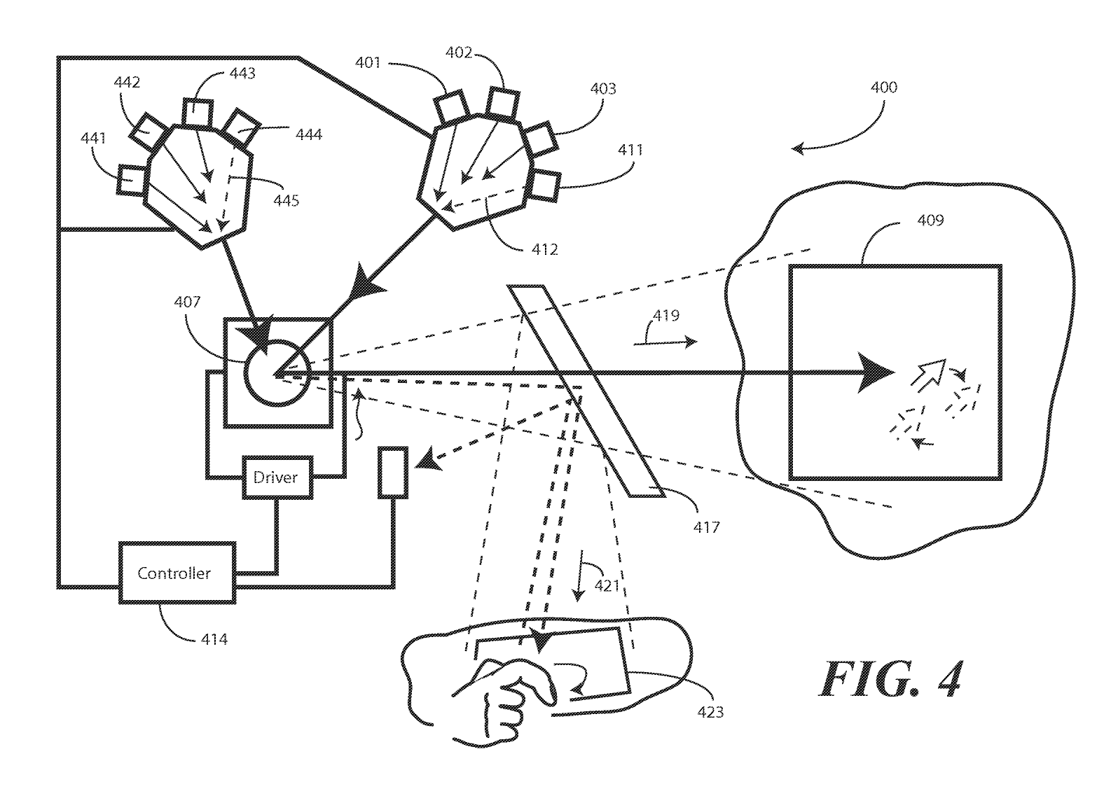

Turning now to FIG. 4, illustrated therein is another imaging system 400 configured in accordance with embodiments of the invention. Many of the imaging system 400 components are the same as in FIG. 1, such as the spatial light modulator 407, the light sources 401,402,403, and the additional light source 411. These components function substantially in the same way as described with reference to FIG. 1 above.

The embodiment of FIG. 4 differs from the embodiment of FIG. 1 in that an additional set of light sources is provided. Specifically, a second set of light sources comprising light sources 441,442,443 is provided. Thus, the imaging system 400 includes a first set of light sources having light sources 401,402,403 and a second set of light sources having light sources 441,442,443.

The second set of light sources permits the controller 414 to create two different images. Specifically, the controller can drive the first set of light sources with a first amplitude modulation to form a first image or series of images, as in the case of video. The second set of light sources can be driven with a second amplitude modulation so as to create a second image or series of images. The partial reflector 417 can then be configured to substantially transmit the first image 409 in the first direction 419 while substantially reflecting the second image 423 in a different direction 421.

An additional light source may be included with one or both sets of light sources. For example, the imaging system 400 can include one additional light source 411 that is associated with the first set of light sources. Alternatively, the imaging system 400 can include one additional light source 444 that is associated with the second set of light sources. The imaging system 400 can further include both additional light source 411 and additional light source 444. Accordingly, the partial reflector 417 can be configured to reflect or transmit either or both additional light sources 411,444 as desired. For example, the partial reflector can be configured to transmit additional light beam 412 while reflecting additional light beam 445. Accordingly, reflections of additional light beam 412 can be interpreted by the controller 414 as control input from gestures within the first image 409, while reflections of additional light beam 444 can be interpreted by the controller as control input form gestures within the second image 423. This multi-image, multi-gesture system gives a user additional degrees of control in moving components of the images.

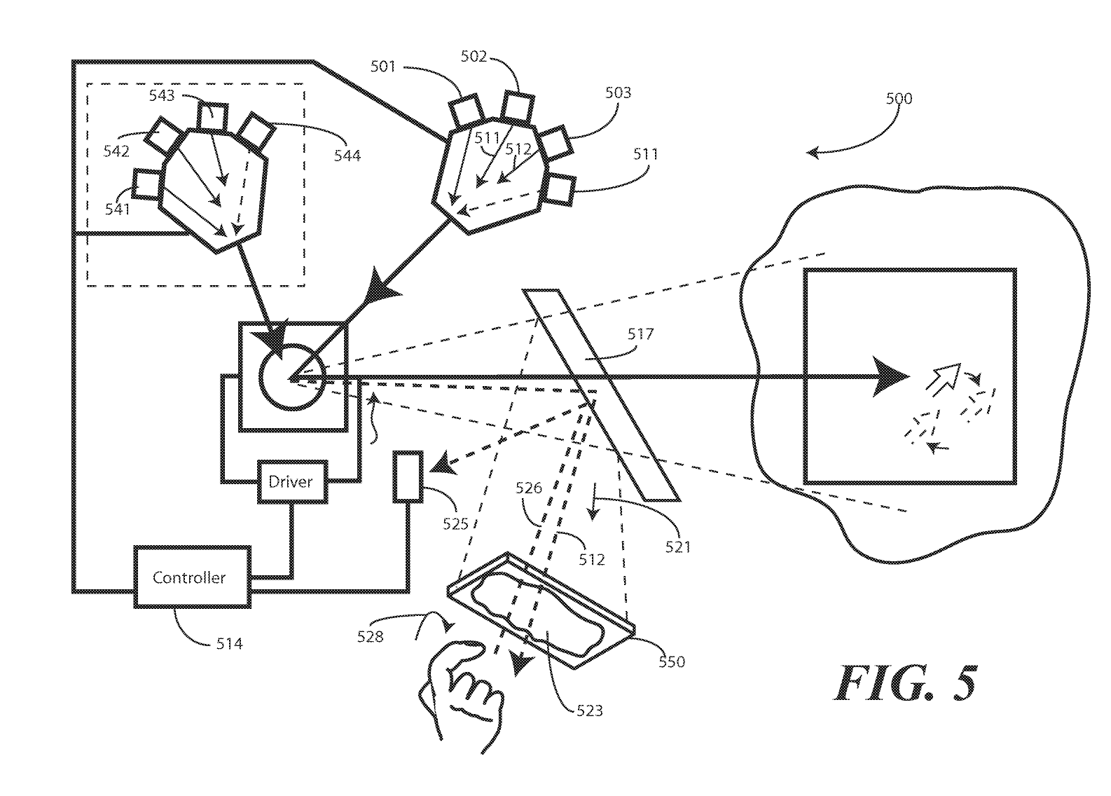

Turning now to FIG. 5, illustrated therein is another image projection system 500 configured in accordance with embodiments of the invention. The operation of the image projection system 500 can be similar to that of FIG. 1 where only a first set of light sources 501,502,503,511 is included. Alternatively, the operation of the image projection system 500 can be similar to that of FIG. 5, when a second set of light sources 541,542,543,544 is included. As noted above, the image projection system 500 can include one or both of alternate light sources 544 and 511.

The major difference between the embodiment of FIG. 5 and previously described embodiments includes the use of a diffuser 550 disposed within the second cone 520 along the second direction 521. The diffuser 550 is configured as a second projection surface for the second cone 520 reflected from the partial reflector 517. The diffuser 550 permits the user to see the image 523 delivered within the second cone 520 from the back of that projection surface.

In one embodiment, the diffuser 550 is configured to at least partially transmit the alternate light beam 512. Accordingly, the user can make hand gestures 528 from the backside of the diffuser 550 with reflections 526 still being delivered to the sensor 525. As with previous embodiments, these reflections 526 can be used as control input by the controller 514.

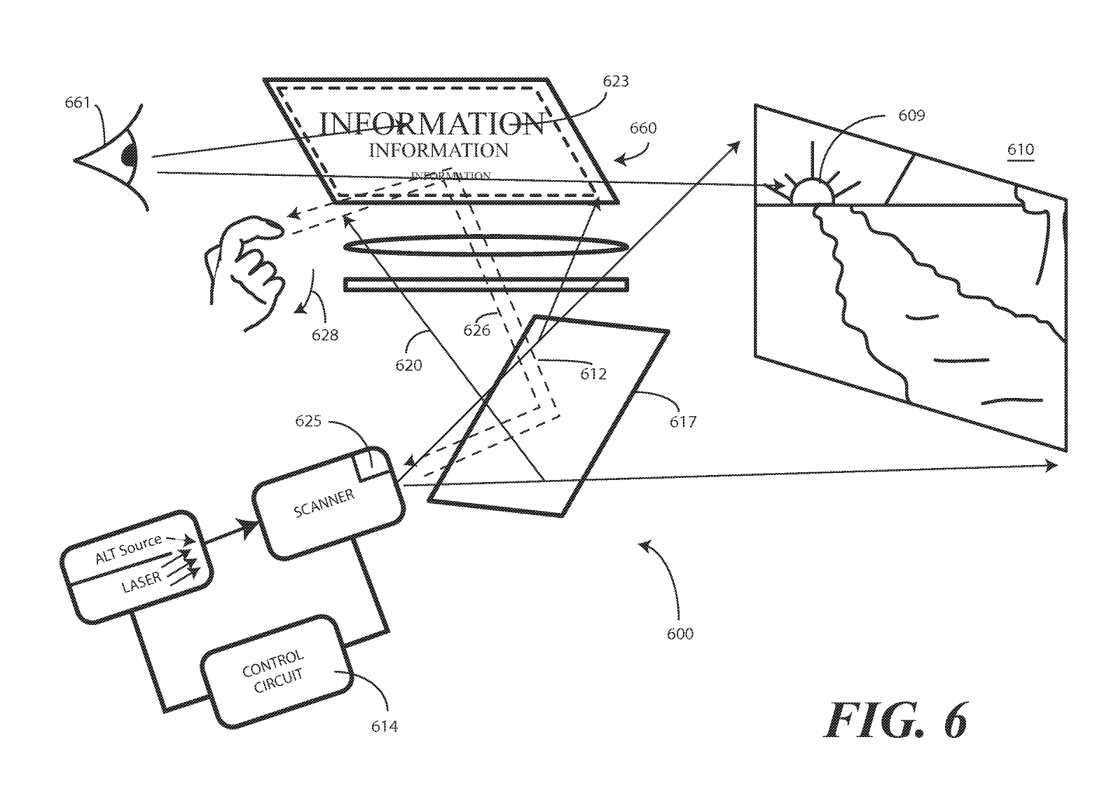

Turning now to FIG. 6, illustrated therein is another image projection system 600 configured in accordance with embodiments of the invention. The operation of the image projection system 600 can be similar to that of FIG. 1 where only a first set of light sources is included. Alternatively, the operation of the image projection system 600 can be similar to that of FIG. 5, when a second set of light sources is included. As noted above, the image projection system 500 can include one or two additional light sources.

The major difference between the embodiment of FIG. 6 and previously described embodiments includes the use of a head-up display 660 disposed within the second cone 620. The head-up display 660 is configured as a second projection surface for the second cone 620 reflected from the partial reflector 617. The head-up display 617 permits the user 661 to see the image 623 delivered within the second cone 620 while also seeing the image 609 delivered to the projection surface. Such a configuration can be advantageous for presenters with the image 623 delivered within the second cone 620 comprises, for example, the text of a presentation that corresponds to the image content presented on the projection surface. Other applications will be readily available to those of ordinary skill in the art having the benefit of this disclosure.

In one embodiment, the head-up display 650 is configured to at least partially transmit an alternate light beam 612. Accordingly, the user can make hand gestures 628 while viewing both the head-up display 660 and the projected image 609 with reflections 626 still being delivered to the sensor 625. To accomplish this, the head-up display 660 may be configured with one or more reflective layers configured to reflect the additional light beam 612, as will be described below. As with previous embodiments, the reflections 626 can be used as control input by the controller 614.

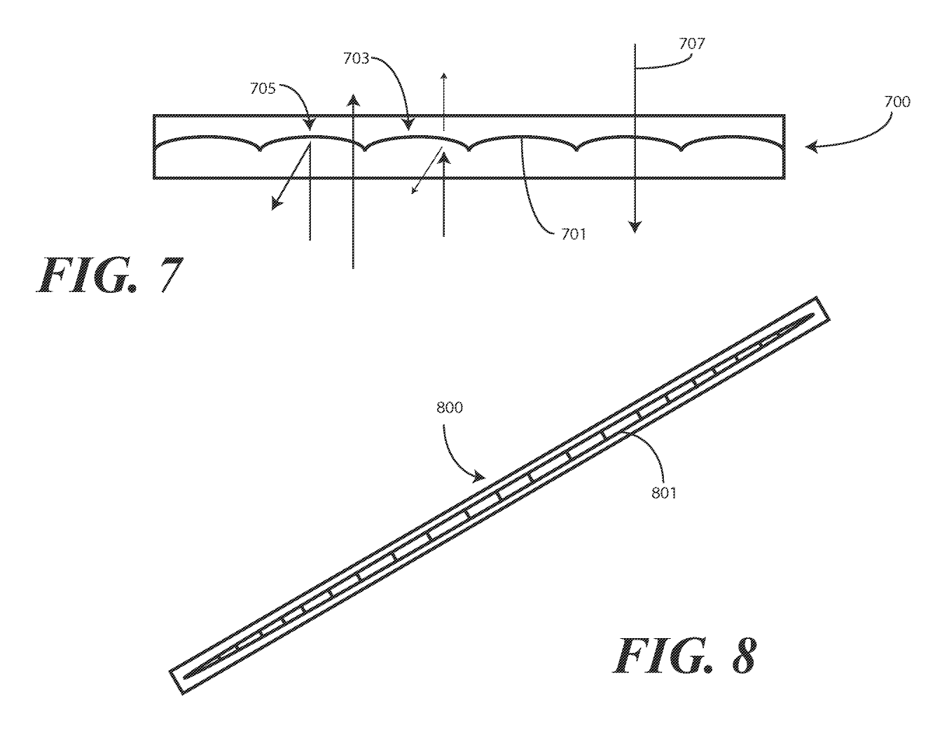

Turning now to FIG. 7, illustrated therein is an optical device 700 configured for use as a projection surface for the head-up display (660) of FIG. 6. The optical device 700 includes reflective layer 701 comprising one or more reflective layers being configured to reflect visible light and the additional light beam while still permitting a user to substantially see through the optical device 700. Such reflective layers are described, for example, in commonly assigned U.S. patent application Ser. No. 12/424,129, filed Apr. 15, 2009 and entitled “Wide Field of View Head-Up Display System,” commonly assigned U.S. Pat. No. 7,715,103, filed Sep. 10, 2007 and entitled “Buried Numerical Aperture Expander Having Transparent Properties,” commonly assigned U.S. patent application Ser. No. 12/194,466, filed Aug. 19, 2008 and entitled “Embedded Relay Lens for Head-Up Displays or the Like,” and commonly assigned U.S. patent application Ser. No. 12/843,424, filed Jul. 26, 2010, and entitled “Variable Reflectivity Notch Filter and Optical Devices Using Same,” each of which is incorporated herein by reference.

The reflective layer 701 is integrated within a body 302. Where the projection system uses red, blue and green lasers, the reflective layer 701 can be configured with a notch filter having a transmission curve configured to substantially reflect 705 red, blue, and green light, as well as the alternate light beam. Light 707 having other wavelengths is permitted to pass through the reflective layer 801.

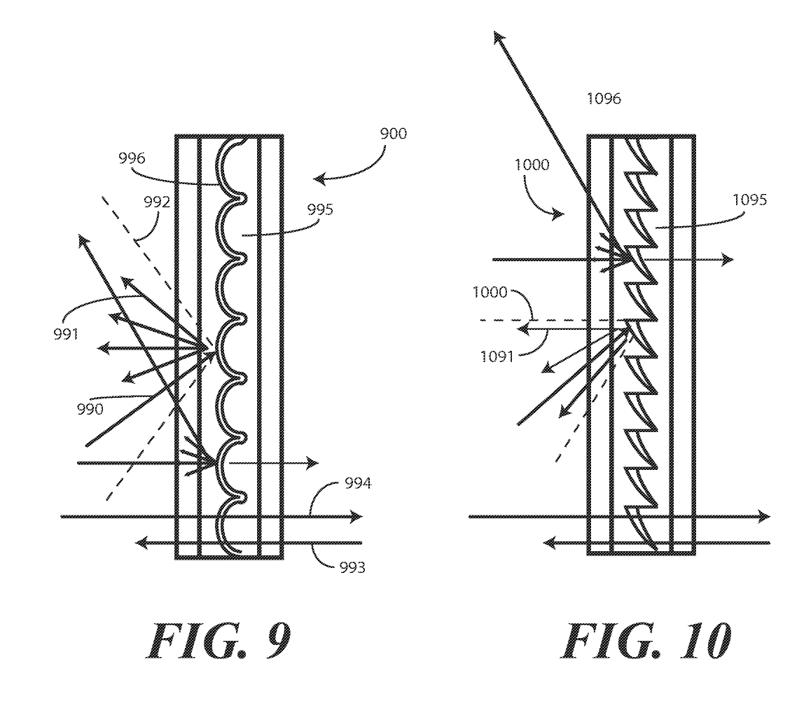

As will be shown in more detail in the discussion of FIGS. 9 and 10, the reflective layer 701 can be integrated with an exit pupil expander 703 so as to work more effectively with laser based systems. The reflective layer 701 can be applied directly on the surface of the exit pupil expander 703 or attached with optical filler materials or epoxy. In one embodiment, the reflective index of the substrate, the exit pupil expander 703, the epoxy, and the cover plate are very similar.

The exit pupil expander 703 can be configured as one or more of a micro lens array, microspheres, nanospheres, a diffuser, or a diffraction grating. The exit pupil expander 703 is configured to expand reflected light. For example, the exit pupil expander 703 can have optical properties resulting from a selected pitch, radius, or spacing of its constituent parts that work to expand incident light when reflected. Further, the exit pupil expander 703 may include various holographic elements, a diffractive grating, or other optical elements capable of optically expanding reflected light rays to result in a controlled angle of reflection or interference pattern.

Turning now to FIG. 8, illustrated therein is a head-up display monitor 800 having a head-up display surface 801 integrated therein. The head-up display surface 801 comprises an exit pupil expander integrated with a selective reflectivity notch filter as described with reference to FIG. 7. The inclusion of an exit pupil expander is still advantageous as the exit pupil expander still works to “spread” reflected light so that the projection surface does not act as a flat mirror reflecting light in accordance with an angle of incidence without distribution. Wavelengths other than those selected for reflection or partial reflection by the transmission curve are transmitted without substantial distortion through the selective reflectivity notch filter.

Turning now to FIGS. 9 and 10, illustrated therein are sectional views of optical devices including selective reflectivity notch filters and exit pupil expanders, either of which is suitable for use as a display monitor in the head-up display (660) of FIG. 6.

Beginning with FIG. 9, the optical device 900 is constructed to substantially reflect certain incident light rays 990 in accordance with a transmission curve. For example, in one embodiment the incident light rays 990 can comprise red, blue, infrared, or green light. The resulting reflected light rays 991 may be expanded to a desired output expansion cone 992 to provide a larger field of view of a reflected image to a viewer. This expansion of reflected light rays 991 may be referred to as “numerical aperture” expansion.

The optical device 900 can also be constructed to allow certain light rays 993 and 994 to be transmitted, at least in part. Such light rays 993,994 therefore travel through either side of the variable reflectivity notch filter integrated within the optical device. Accordingly, the optical device 900 has both reflective and transmissive properties, which are defined by the transmission curve. This configuration works well in head-up display applications where it can be desirable to display an image from a corresponding image projection source on optical device 900 while still allowing the optical device 900 to be at least partially transparent so as to allow a user to see through the optical device while simultaneously viewing the displayed image.

The exit pupil expander 995 may be either an ordered array of microstructures or a randomized light diffuser. The exit pupil expander 995 can be, for example, a micro lens array (MLA). The exit pupil expander 995 can be manufactured from a molded liquid polymer, or may be formed via other methods. In one embodiment, the exit pupil expander 995 may be embossed by a roll embossing process. In another embodiment, the exit pupil expander 995 may comprise glass or plastic beads, or microspheres or nanospheres, or similarly shaped objects capable of functioning as an optical diffuser or lens. The exit pupil expander 995 may have optical properties resulting from a selected pitch, radius, or spacing of its constituent parts to expand incident light that is reflected. The selective reflectivity notch filter 996 may be disposed on the exit pupil expander 995 to impart selective reflective properties in accordance with a transmission curve. The selective reflectivity notch filter 996 may comprise a thin coating having reflective properties at desired wavelengths so as to allow some light to be substantially reflected, some light to be partially reflected, and some light to be substantially transmitted.

Turning now to FIG. 10, illustrated therein is a cross sectional view of an alternate embodiment of an optical device 1000 configured with embodiments of the invention. The optical device 1000 of FIG. 10 is similar to that of FIG. 9 in that it includes a selective reflectivity notch filter 1096. The optical device 1000 of FIG. 10 differs from that of FIG. 9 in that it includes an asymmetrical exit pupil expander 1095 that is coupled with a variable reflectivity notch filter.

The exit pupil expander 1095 of FIG. 10 is designed to have an asymmetrical structure so that reflected light rays 1091 are directed in a desired direction according to the structures of the exit pupil expander 1095. For example, the exit pupil expander 1095 may have an asymmetrical structure to cause reflected light rays 1091 to have a directional bias from the angle of reflection that would not otherwise occur if exit pupil expander 1095 were symmetrical.

In the illustrative embodiment of FIG. 10, the exit pupil expander 1095 has an asymmetry to bias reflected light rays 1091 downward, which results in the output expansion cone 1010 to also be directed downward. Alternatively, the exit pupil expander 1095 may have an asymmetry to bias reflected light rays 651 upward as desired. Such an asymmetrical structure may be utilized to direct the output expansion cone 1010 to a desired location according to the particular application. It is well to note that the “asymmetricalness” of the elements of the exit pupil expander 1095 may vary from element to element. For example, the asymmetry of the elements located toward the ends of the exit pupil expander 1095 may have more asymmetry than elements located toward the center of the exit pupil expander 1095. Additionally, centrally located elements may have very little or no asymmetry. Such varying asymmetry directed toward the center of the exit pupil expander 1095 may be utilized to result in a smaller, narrower output expansion cone. Varying asymmetry directed away from the center of the exit pupil expander 1095 may result in a larger, wider output expansion cone.

As set forth herein, a selective reflector is used as a beam folder in an imaging system to pass one image cone while reflecting another. The selective reflector can perform the reflection based upon polarization, wavelength, or even by passing a portion of a cone and reflecting another portion. Depending upon the number of light sources, one or multiple images can be created. An additional light source can be included and reflected off the selective reflector. Reflections of the light from the additional light source can be detected by a sensor and delivered to a control circuit, which can use the reflections as control inputs.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. An imaging system, comprising:
one or more light sources configured to produce one or more light beams;
an additional light source configured to produce an additional light beam;
a spatial light modulator configured to produce images on a projection surface by scanning the one or more light beams and the additional light beam within an image cone oriented in a first direction;
a partial reflector disposed within the image cone and configured to pass at least a portion of the one or more light beams and reflect at least a portion of the additional light beam within a second cone oriented in a second direction that is different from the first direction.

2. The imaging system of claim 1, further comprising:
a sensor configured to receive reflections of the additional light beam from the partial reflector; and
a control circuit, operable with the spatial light modulator, and configured to use the reflections as an input to control the imaging system.

3. The imaging system of claim 2, wherein the one or more light sources comprise visible light sources, wherein the additional light source comprises a non-visible light source.

4. The imaging system of claim 3, wherein the non-visible light source comprises an infrared light source.

5. The imaging system of claim 2, wherein the partial reflector is configured to pass substantially all of the one or more light beams.

6. The imaging system of claim 2, wherein the partial reflector is configured to reflect substantially all of the additional light beam along the second direction.

7. The imaging system of claim 2, wherein the reflections of the additional light beam comprise reflections from a user's hand.

8. The imaging system of claim 1, further comprising a diffuser disposed in the second direction, wherein the diffuser is configured as a second projection surface for the second cone reflected from the partial reflector.

9. The imaging system of claim 8, wherein the diffuser is further configured to at least partially transmit the additional light beam.

10. The imaging system of claim 1, further comprising a head-up display surface disposed within the second cone.

11. The imaging system of claim 1, wherein the spatial light modulator comprises a MEMS scanning mirror.

12. The imaging system of claim 1, wherein the partial reflector comprises a dielectric coating.

13. The imaging system of claim 1, wherein the one or more light sources comprise a first set of light sources driven by a first amplitude modulation so as to produce a first image, and a second set of light sources driven by a second amplitude modulation so as to produce a second image, wherein the partial reflector is configured to substantially transmit the first image and substantially reflect the second image.

14. The imaging system of claim 13, wherein the additional light source comprises a plurality of additional light sources, wherein the partial reflector is configured to transmit a first additional light beam and reflect a second additional light beam.

15. The imaging system of claim 14, further comprising:
a sensor configured to receive reflections of the first additional light beam and the second additional light beam; and
a control circuit, operable with the spatial light modulator, and configured to use one or more of the reflections of the first additional light beam, the reflections of the second additional light beam, or combinations thereof, as an input to control the imaging system.

16. An image projection system, comprising:
a spatial light modulator configured to scan light in an image cone oriented in a first direction;
a selective reflector configured to reflect a portion of the image cone in a second direction;
a sensor configured to receive reflections of some of the portion; and
a control circuit configured to use the reflections as input for controlling the image projection system.

17. The image projection system of claim 16, wherein the light comprises a non-visible light beam, further wherein the reflections comprise reflections of the non-visible light beam.

18. The image projection system of claim 17, wherein the non-visible light beam comprises one of infrared or ultraviolet light.

19. The image projection system of claim 18, wherein the portion comprises light modulated in accordance with a first amplitude modulation so as to form a first image, wherein the light other than the portion comprises light modulated in accordance with a second amplitude modulation so as to form a second image.

20. The image projection system of claim 16, wherein the first direction is substantially orthogonal with the first direction.
